(19) United States
(12) Patent Application Publication
(10) Pub. No.: US 2006/0176565 A1
(43) Pub. Date: Aug. 10, 2006

(54) Prism lens film and flat light emitting device

(75) Inventor: Kimitoshi Nagao, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/350,785

(22) Filed: Feb. 10, 2006

(30) Foreign Application Priority Data
Feb. 10, 2005 (JP) P.2005-034593
Mar. 14, 2005 (JP) P.2005-071042

(51) Int. Cl. G02B 27/10

(52) U.S. Cl. 359/619

(57) ABSTRACT

A prism lens film deflecting and outputting light is provided and includes a plurality of lens parts forming an irregular pattern on the light-output side surface, the irregular pattern deflecting the light. One aspect of the prism lens film includes reflecting parts provided between the lens parts for reflecting the introduced light. In another aspect of the prism lens film, a plurality of lens parts has trapezoidal shapes in a sectional view, first concave curved surfaces are formed between the lens parts, and second concave curved surfaces are formed on the upper surfaces of the lens parts.

### FIELD OF THE INVENTION

The present invention relates to a flat panel display device in a flat television, a portable telephone, a digital camera, a car navigator, a mobile PC, a PDA, a note PC, a desk top PC and cash dispenser terminals of banks, etc. and a flat lighting device.

### BACKGROUND OF THE INVENTION

Usually, in a display device of a liquid crystal, to improve brightness by enhancing the use efficiency of light, one or two triangular roof-shaped prism lens films have been arranged on the surface of a light guide plate of a back light in a light emitting device. Then, when an emitted light is incident on the prism lens films at an angle substantially vertical from the light guide plate, a part of the emitted light happens to be refracted to a direction deviating from the vertical direction or to be reflected and return to the light guide plate side. Thus, the use efficiency of the light may be sometimes deteriorated. Accordingly, to improve the use efficiency of the light, a further improvement is studied (for instance, see JP-A-7-104271).

As shown in FIG. 18, in a usual triangular roof-shaped prism lens film 100, when lights La, Lb and Lc are incident from a light guide plate 102, the lights Lb and Lc whose incident angles are near to a vertical direction (the vertical direction in FIG. 18) are refracted in lens parts 101a formed in an output side surface and deflected upward. However, the light La whose incident angle has a large angle difference relative to the vertical direction is output from a position horizontally deviating from a position where the light is incident in the prism lens film 100. Then, the light La is not output to an upper position corresponding to the incident position of the prism lens film 101. As described above, the light incident upon the prism lens film 100 is not deflected in the vertical direction in the position of the lens part where the light is incident and is dissipated in the horizontal direction of the prism lens film 100. As a result, since the sharpness of an image displayed on a display device is deteriorated, there is a room for improvement.

Further, the dissipated light is refracted and reflected at an unexpected angle-by the lens part 101a of the prism lens film 100 and returns to an incident side, so that the use efficiency of the light is lowered.

Also, as shown in FIG. 19, in a usual triangular roof shaped prism lens film 100, when an emitted light Lr is vertically incident from a light guide plate 102, the emitted light is reflected by a lens part 101 formed in an output side so that the light returns to an incident side. Accordingly, the use efficiency of light is lowered the more for the light reflected and returning to the incident side. As a result, the brightness of a display device is limited.

### SUMMARY OF THE INVENTION

An object of an illustrative, non-limiting embodiment of the present invention is to provide a prism lens film, which can improve the use efficiency of light, and a flat light emitting device using the prism lens film.

The object of the present invention is achieved by below-described constitutions.

(First Aspect)

(1) A prism lens film deflecting and outputting light introduced thereto, which includes: a plurality lens parts including an irregular pattern on a light-output side of the prism lens film, the irregular pattern deflecting the light; and a reflecting part between the lens parts, the reflecting part reflecting the light.
(2) The prism lens film according to the above (1), wherein the plurality of lens parts are linear parts arranged in parallel with a planar direction in a surface of the light-output side.
(3) The prism lens film according to the above (1), wherein the plurality of lens parts is two-dimensionally arranged in parallel with a planar direction in a surface of the light-output side.
(4) The prism lens film according to any one of the above (1) to (3), wherein the lens parts are formed at equal intervals.
(5) The prism lens film according to any one of the above (1) to (3), wherein a part or all of the lens parts are formed at different intervals.
(6) A prism lens film including a plurality of films superposed, the films including at least one prism film according to any one of the above (1) to (5).
(7) A flat light emitting device including; a prism lens film according to any one of the above (1) to (6); and a light source on a light-incident side of the prism lens film opposite the light-output side.
   (Second Aspect)
(8) A prism lens film deflecting and outputting light introduced thereto, which includes: a plurality of lens parts including an irregular pattern on a light-output side of the prism lens film, the irregular pattern deflecting the light, the plurality of lens parts linearly extending along a planar direction in a surface of the light-output side; and a first concave curved surface between the lens parts, wherein each of the lens parts has a trapezoidal shape in a sectional view and has a second concave curved surface on an upper surface thereof.
(9) The prism lens film according to the above (8), wherein a part or all of the lens parts are formed at different intervals.
(10) The prism lens film according to the above (8) or (9), wherein when a coordinate in a thickness direction in a sectional view of the prism lens film is set as a y-axis and a coordinate in a planner direction of the prism lens film is set as an x coordinate, the first concave curved surface is formed along a quadratic curve represented by formula;
   y=ax²+bx+c
   wherein a, b and c each independently is a constant value.
(11) A prism lens film comprising two prism lens films each according to any one of the above (8) to (10), the two prism lens films being superposed so that the lens parts in one of the two prism lens films intersect at right angles to the lens parts in the other of the two prism lens films.
(12) A prism lens film deflecting and outputting light introduced thereto, which includes: a plurality of lens parts including an irregular pattern on a light-output side of the prism lens film, the irregular pattern deflecting the light, the plurality of lens prism films being two-dimensionally arranged along a planar direction in a surface of the light-output side; and a first concave curved surface between the lens parts, wherein each of the lens parts has a trapezoidal shape in a sectional view and has a second concave curves surface on an upper surface thereof.
(13) The prism lens film according to the above (12), wherein a part or all of the lens parts are disposed at different intervals.
(14) The prism lens film according to the above (12) or (13), wherein when a coordinate in a thickness direction in a sectional view or the prism lens film is set as a y-axis and a coordinate in a planner direction of the prism lens film is set as an x coordinate, the first concave curved surface is formed along a quadratic curve represented by formula:
   y=ax²+bx+c
   wherein a, b and c each independently is a constant value.
(15) A prism lens film including a plurality of films superposed, the films including to at least one prism lens film according to any one of the above (12) to (14),
(16) A flat light emitting device including: a prism lens film according to any one of the above (8) to (15); and a light source on a light-incident side of the prism lens film opposite the light-output side.

The prism lens film according to an exemplary embodiment of the first aspect of the present invention is provided with reflecting parts between a plurality of lens parts forming an irregular pattern. Accordingly, the reflecting parts make it possible to prevent light introduced from an incident surface side of the prism lens film from advancing to other lens parts different from a lens part corresponding to the position where the light are incident and being output from output surfaces in other lens parts. In such a way, the light incident upon the prism lens film can be prevented from dissipating in the horizontal direction of the prism lens film without being deflected in the vertical direction in the lens part at the position where the light are incident. Therefore, the prism lens film is applied to a display device so that the sharpness of an image to be displayed can be prevented from being deteriorated.

Further, since the light incident upon the prism lens film can be prevented from dissipating, the incident light does not advance in the prism lens film and a phenomenon does not arise that the light are refracted and reflected at unexpected angles and return to the incident side. Accordingly, the use efficiency of the light can be improved.

Further, a flat light emitting device according to an exemplary embodiment of the first aspect of the present invention includes the above-described prism lens film, the use efficiency of the light from a light source can be improved.

In the output side surface of the prism lens film according to an exemplary embodiment of the second aspect of the present invention, the lens parts having trapezoidal shapes in a sectional view are formed and the first concave curved surfaces are formed between the lens parts. A light vertically incident on an incident side surface from the light source of the prism lens film moves forward in the prism lens film and a part of the light is applied to the first concave curved surface forming the side surface of the lens part. At this time, a part of the first concave curved surface irradiated with the light is curved inward of the lens part. Thus, vertically incident light is different in their reflected direction depending on its position in the horizontal direction (the planar direction of the prism lens film). Accordingly, since the vertically incident lights are not uniformly reflected to the same direction as in the prism lens film 100 shown in FIG. 19, an incident light having an angle near to a vertical is directly output upward and an obliquely incident light having an angle wider than that of a usual light can be refracted upward. Consequently, the use efficiency of light can be improved.

Further, since the flat light emitting device according to an exemplary embodiment of the second aspect of the present invention is provided with the prism lens film, the use efficiency of the light emitted from the light source can be improved. Accordingly, such a flat light emitting device is applied to a display device so that the brightness of the emitted light on a display screen can be improved.

According to an exemplary embodiment of the present invention, the prism lens film, which can improve the use efficiency of the light from the light source, for example, by preventing the light from the light source from dissipating, and a flat light emitting device using the prism lens film can be provided.

### BRIEF DESCRIPTION OF THE DRAWINGS

FIG. 1 is a sectional view showing a first embodiment of a prism lens film according to a first aspect of the present invention and a flat light emitting device using the prism lens film.

FIG. 2 is an enlarged view of main parts of the prism lens film shown in FIG. 1.

FIG. 3 is a perspective view of the prism lens film of the first embodiment.

FIGS. 4A and 4B are diagrams for explaining an illustrative, non-limiting means for forming reflecting parts in the prism lens film.

FIGS. 5A and 5B are diagrams for explaining another illustrative, non-limiting means for forming reflecting parts in the prism lens film.

FIG. 6 is a diagram for explaining still another illustrative, non-limiting means for forming reflecting parts in the prism lens film.

FIG. 7 is a modified example of the prism lens film of the first embodiment,

FIG. 8 is a view showing a second embodiment of a prism lens film according to a first aspect pf the present invention.

FIG. 9 is a plan view showing a state of the prism lens film of FIG. 8 viewed from an upper part.

FIG. 10 is a sectional view showing a first embodiment of a prism lens film according to a second aspect of the present invention and a flat fight emitting device using the prism lens film.

FIG. 11 is a diagram for explaining the state of a curved surface of the prism lens film according to a second aspect of the present invention in a sectional view.

FIG. 12 is a view showing a section of the prism lens film according to a second aspect of the present invention.

FIG. 13 is a perspective view showing the prism lens film according to a second aspect of the present invention.

FIG. 14 is a view showing a second embodiment of a prism lens film according to a second aspect of the present invention.

FIG. 15 is a sectional view taken along a line A-A of FIG. 14.

FIG. 16 is a view showing a third embodiment of a prism lens film according to a second aspect of the present invention.

FIG. 17 is a sectional view taken along a line B-B of FIG. 16,

FIG. 18 is a sectional view showing a prism lens film in the related art.

FIG. 19 is a sectional view showing a prism lens film in the related art.

### DETAILED DESCRIPTION OF THE INVENTION

Now, exemplary embodiments of the present invention will be described below in detail by referring to the drawings.

(First Aspect)

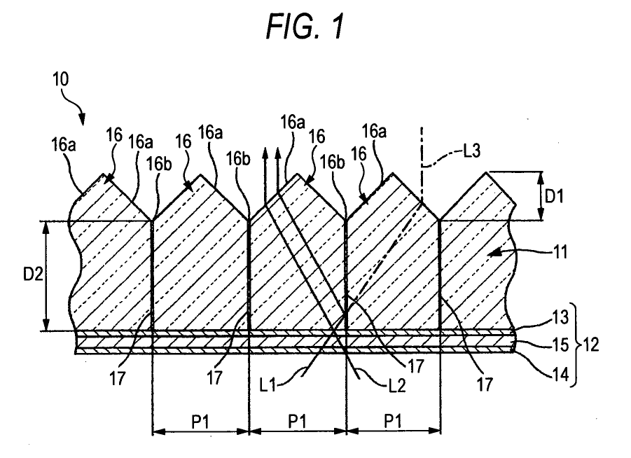

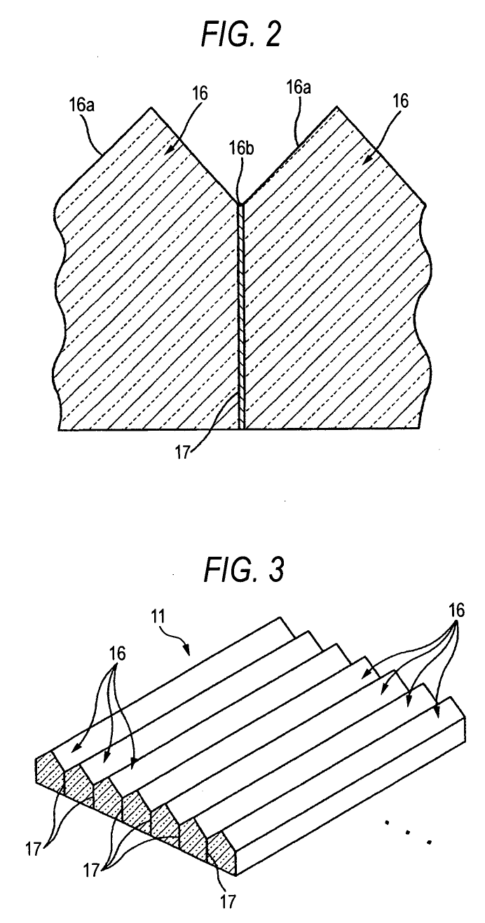

FIG. 1 is a sectional view showing a first embodiment of a prism lens film according to a first aspect of the present invention and a flat light emitting device using the prism lens film. FIG. 2 is an enlarged view of main parts of the prism lens film shown in FIG. 1. FIG. 3 is a perspective view of the prism lens film.

As shown in FIG. 1, a flat light emitting device 10 includes a prism lens film 11 and a flat light source 12. The prism lens film 11 is stacked on the flat light source 12. The prism lens film 11 is arranged under a state in which an irregular pattern including a plurality of lens parts 16 is directed to an opposite side to the flat light source 12.

The flat light source 12 includes a lower electrode layer 14, an upper electrode layer 13 and a light emitting layer 15 provided between the upper electrode layer 13 and the lower electrode layer 14. The lower electrode layer 14 may have functions as an electrode and a reflecting layer for reflecting emitted light generated on the light emitting layer 15.

The flat light emitting device is not limited to a device having the flat light source 12 and may include a back light and light emitted from the back light may be deflected in the vertical direction by a light guide plate to be incident upon a prism lens film.

The prism lens film 11 is a light transmitting film formed with, for instance, glass, plastic (polycarbonate, acryl, etc.) and materials high in their light transmittance and rich in their plane property and moldability are preferably employed. As materials of the prism lens film 11, a material having a refractive index of 1.4 or higher is preferable to enhance a converging effect.

As shown in FIGS. 1 and 3, on an upper surface as an output side surface (a light-output side surface) of the prism lens film 11, the plurality of linear lens parts 16 are formed. The lens parts 16 are respectively arranged in parallel with a planar direction to form the irregular pattern. The irregular pattern has a substantially triangular wave form in the output side surface in plan view. That is, the irregular pattern in the output side surface is composed of top parts formed with the lens parts 16 and bottom parts defined between the lens parts 16.

In the prism lens film 11, reflecting parts 17 are provided for reflecting introduced fight between the lens parts 16. The reflecting parts 17 are located in boundary parts 16b at the bottom parts between the lens parts 16 and are thin film shaped members having reflecting surfaces parallel to the vertical direction (a vertical direction in FIG. 1) of the prism lens film 11.

As shown in FIG. 1, pitches P1 of arranging the lens pats 16 of the prism lens film 11 are equal.

An average size of the lens part 16 is preferably equal to or smaller than the size of a liquid crystal display element or a color filter. A cycle for arranging the lens parts 16 is preferably set to 5 μm to 500 μm.

Assuming that the depth of the bottom parts between the lens parts 16 is D1 and an apex angle of the prism is θ1, D1 can be expressed by the following formula. The apex angle θ1 of the prism preferably ranges from 30° to 150°, and more preferably ranges from 60° to 110°.
D1=P1/2 tan(θ1/2)

Further, the thickness D2 from the depth D1 of the bottom part to the bottom surface of the prism in a light source side is preferably set to 1 to 3 times as thick as the pitch P1 of arranging the prisms.

In the prism lens film 11 of this embodiment, when the light is incident from an incident side surface, an incident light that is greatly inclined to the vertical direction is prevented from moving straight to the reflecting part 17 located between the lens parts 16 and is reflected to a lens surface 16a side of the lens part 16 at an angle equal to an angle of incidence upon the reflecting part 17. At this time, assuming that a critical angle is θc, when the angle of the light incident upon the reflecting part from the bottom surface of the prism is located within a range of 1° to (90-θc)°, all the lights are reflected. When there is no air layer between the light source and the bottom surface of the prism, the lights located within a range of angle determined by the refractive indexes of both of them are incident on the reflecting parts.

As shown in FIG. 1, an explanation is given to a case in which incident lights L1 and L2 are incident in the directions shown by arrow marks. When the light is incident at an angle with a small inclination relative to the vertical direction like the incident light L2, the incident light L2 is not reflected by the reflecting part 17 and moves upward of the lens part 16 in a position where the light is incident, and is refracted in the lens surface 16a and output.

However, when the light is incident toward the reflecting part 17 like the incident light L1, the incident light L1 is reflected by the reflecting part 17, then, moves upward of the lens part 16 in a position where the light is incident, and is refracted in the lens surface 16a and output like the incident light L2. In the case of the usual prism lens film in which the reflecting parts 17 are not provided, a light advances to other lens part side at a position different from the position of the lens part where the light is incident like a light L3 shown by an arrow mark of a dashed line and is deflected in other lens part. Accordingly, the light cannot be properly output upward in the vertical direction to the position where the light is incident. However, in the prism lens film 11 of this embodiment, the incident light can be prevented from being output from a lens part at a horizontally different position by the reflecting part 17.

Further, a light in the vertical direction and a light inclined at a slight angle relative to the vertical direction among the incident lights are not blocked by the reflecting parts 17 and substantially vertically move upward of the lens parts 16 and are output from the lens surfaces 16a.

The prism lens film 11 of this embodiment is provided with the reflecting parts 17 between the plurality of lens parts 16 forming the irregular pattern. The reflecting parts 17 make it possible to prevent the light introduced from the incident surface side of the prism lens film 11 from advancing to other lens parts 16 different from the lens part 16 corresponding to the position where the light is incident, being refracted by other lens parts 16, and vertically deflected and output from the output surfaces. In such a way, the light incident upon the prism lens film 11 can be prevented from dissipating in the horizontal direction of the prism lens film 11 without being deflected vertically in the lens part 16 in the position where the light is incident. Thus, the prism lens film 11 is applied to a display device so that the sharpness of an image to be displayed can be prevented from being deteriorated.

Further, since the light incident upon the prism lens film 11 can be prevented from dissipating, the incident light does not advance in the prism lens film 11 and a phenomenon does not arise that the light is refracted and reflected at unexpected angles and return to an incident side. Thus, the use efficiency of the light can be improved, Further, since the flat light emitting device 10 according to a first aspect of the present invention is provided with the prism lens film 11, the use efficiency of the light from the light source can be improved.

In the prism lens film 11 of this embodiment, the constitution is not limited to a regular arrangement that the lens parts 16 are arranged at equal intervals as in the above-described structure and the lens parts 16 may be irregularly arranged so that a moire generated between the arrangement of pixels of a liquid crystal and the prism lens can be prevented. As the irregular arrangement, for instance, a part or all of the lens parts 16 may be formed at different intervals.

Now, exemplary means for forming the prism lens film 11 provided with the reflecting parts 17 will be described below. In the following explanation, members having the same constitutions and operations as those of the already described members are designated by the same reference numerals or equivalent reference numerals to simplify or omit the explanation.

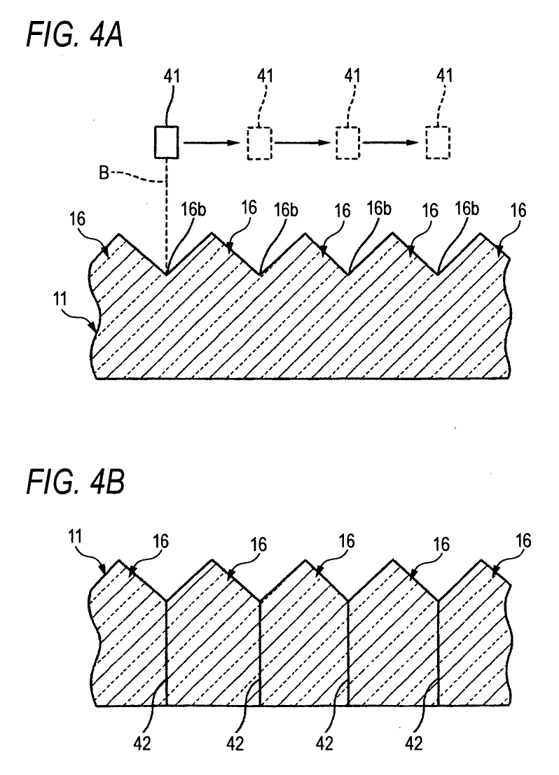

FIGS. 4A and 4B are diagrams for explaining means for forming the reflecting parts in the prism lens film.

As shown in FIG. 4A, the output side surface in which the irregular pattern is formed in the prism lens film 11 is irradiated with a laser beam B from a laser applying part 41 to irradiate the boundary parts 16b between the lens parts 16 with the laser beam. On the boundary part 16b, a flat part is provided that has a width about 1.5 times as wide as the diameter of the laser beam so that the laser beam is vertically incident thereon. The laser applying part 41 is driven in parallel with the planar direction of the output side surface of the prism lens film 11 so that the laser beam B can be applied to each boundary part 16b between the lens parts 16.

On the boundary parts 16b between the lens parts 16 to which the laser beam B is applied, very small air bubbles are generated. As shown in FIG. 4B, the air bubbles serve as reflecting parts 42 and parts in which the air bubbles are generated reflect the light introduced to the prism lens film 11. As the laser beam, for instance, Co₂ laser, eximer laser and UV-YAG laser may be employed.

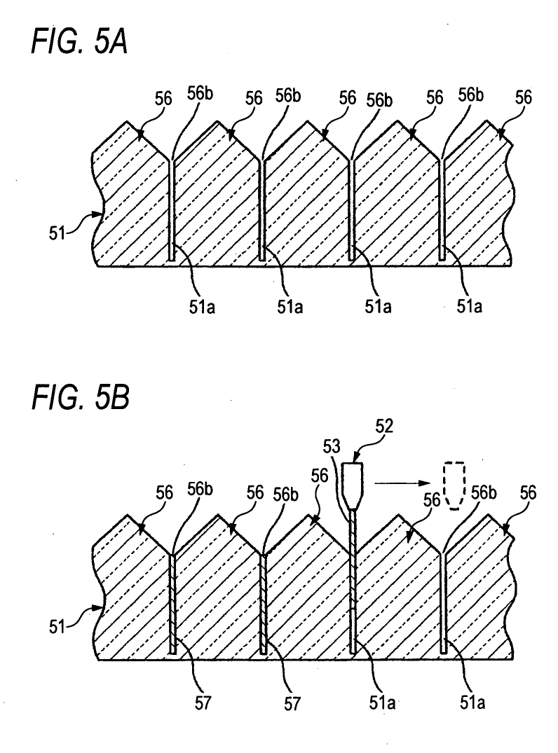

FIGS. 5A and 5B are diagram showing another means for forming reflecting parts in a prism lens film.

As shown in FIG. 5A, voids 51a having prescribed depth are previously formed respectively in boundary parts 56b between lens parts 56 of a prism lens film 51. Then, as shown in FIG. 5B, a member 53 having a light reflection property or a light diffusion property is supplied to the voids 51a from a supply unit 52 to permeate into the voids. Thus, reflecting parts 57 can be formed. Here, as the member having the light reflection property or the light diffusion property, for instance, titanium white, white paint or a pigment may be exemplified.

The prism lens film that has the voids 51a formed on the boundary parts 56b between the lens parts 56 can be obtained by previously using a mold in which a thin plate for defining the voids 51a is arranged in a comb shape as a forming die upon forming the prism lens film 51.

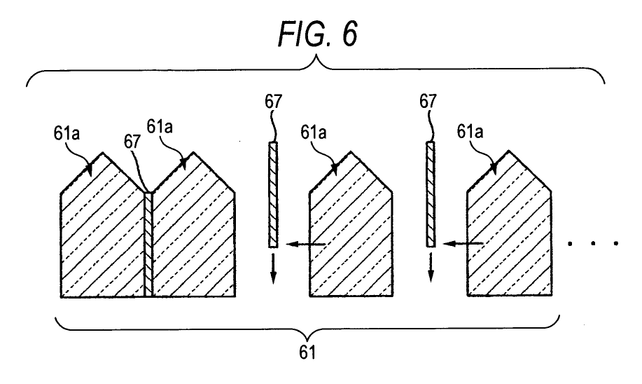

FIG. 6 is a diagram showing still another means for forming reflecting parts in a prism lens film.

As shown in FIG. 6, substantially pentagonal long post shaped lens parts 61a in sectional view sandwich previously formed thin film shaped reflecting parts 67 between them and are sequentially connected together so that a prism lens film 61 can be obtained in which the reflecting parts 67 are provided between the lens parts 61a.

As forming means of the prism lens film 11, there are means, as well as the above-described means, in which thin film shaped reflecting members (an aluminum foil, etc.) are arranged and formed in a mold form-work and the obtained product is directly arranged in the prism lens.

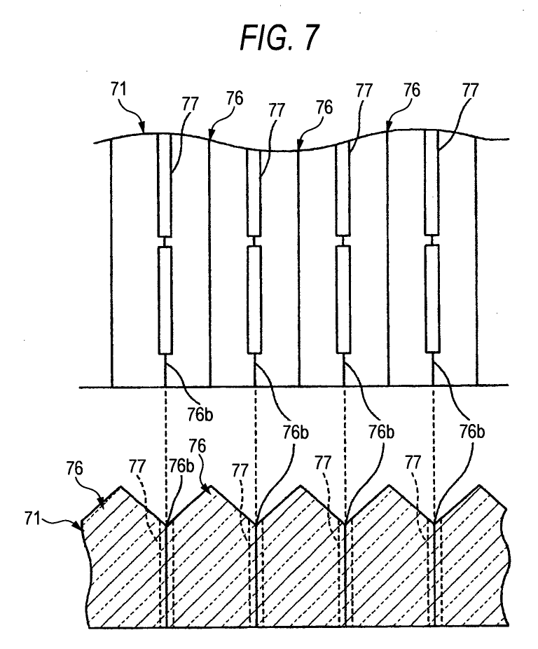

In the prism lens film 11 shown in FIG. 1, the reflecting part 17 is provided in the entire part of the boundary part 16b between the lens parts 16. However, the present invention is not limited thereto. FIG. 7 is a diagram showing a modified example of the prism lens film of the first embodiment. As shown in FIG. 7, reflecting parts 77 provided in boundary parts 76b between lens parts 76 of a prism lens film 71 may be intermittently formed.

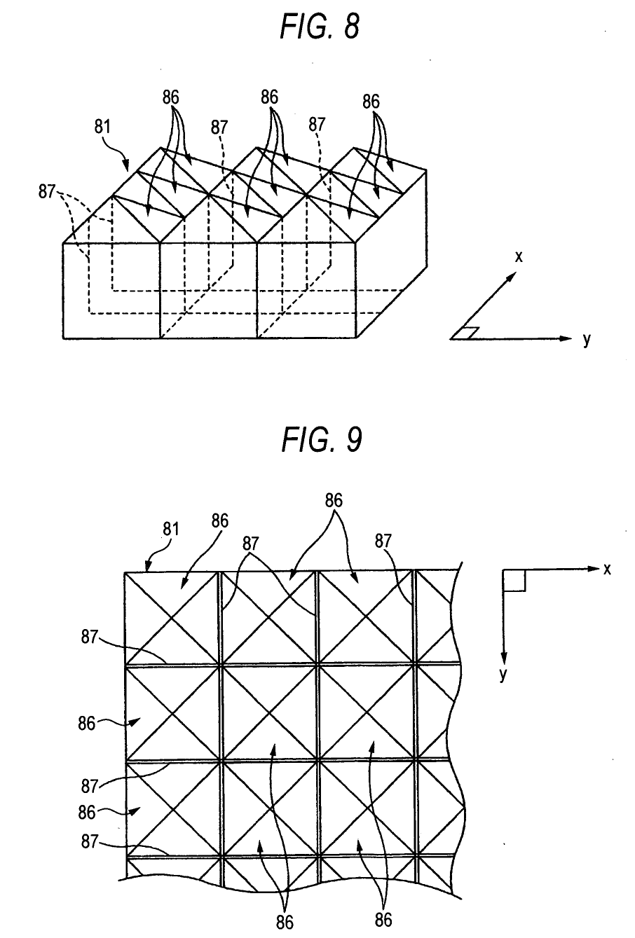

FIG. 8 is a diagram showing a second embodiment of a prism lens film according to a first aspect of the present invention. FIG. 9 is a plan view showing the state of the prism lens film shown in FIG. 8 viewed from an upper part.

As shown in FIGS. 8 and 9, in the prism lens film 81 of the second embodiment, a plurality of lens parts 86 having substantially pyramid shapes are two-dimensionally (a plane defined by x-y directions) arranged by placing square surfaces on bottom surfaces.

Reflecting parts 87 are respectively formed between the lens parts 86 in the x direction and between the lens parts 86 in the y direction. The reflecting parts 87 can be formed by the means shown in FIGS. 4A, 4B, 5A, 5B and 6.

In the prism lens film 81 of this embodiment, light of incidents light that are inclined in any of directions relative to the vertical direction can be reflected on the reflecting parts 87. As a result, light can be prevented from being output from the lens parts 86 at positions different in a planar direction except the lens parts 86 corresponding to position where the light is incident.

In the prism lens film 81 of this embodiment, an incident light that is inclined in the x direction or the y direction relative to the vertical direction can be reflected by the reflecting parts 87, so that the incident light can be more assuredly prevented from dissipating. Further, the incident light does not advance in the horizontal direction in the prism lens film 81 and a phenomenon does not arise that the incident light are refracted and reflected at unexpected angles in the lens parts 86 at positions different from the positions where the light are incident and return to an incident side. Accordingly, the use efficiency of the light can be improved.

Further, the prism lens film 81 of this embodiment is disposed on the flat light source shown in FIG. 1 or on the light guide plate for deflecting the light from the light source such as a back light. Thus, a flat light emitting device good in the use efficiency of the light can be obtained.

The present invention is not limited to the above-described embodiments and suitable modifications and improvements may be made.

For instance, two or more prism lens films 11 of the embodiment may be overlapped one upon another in the vertical direction.

(Second Aspect)

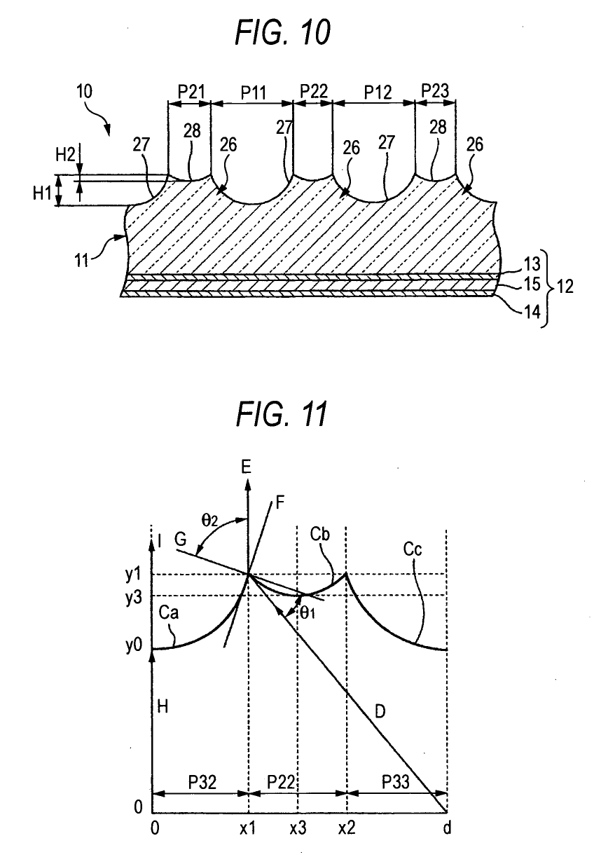

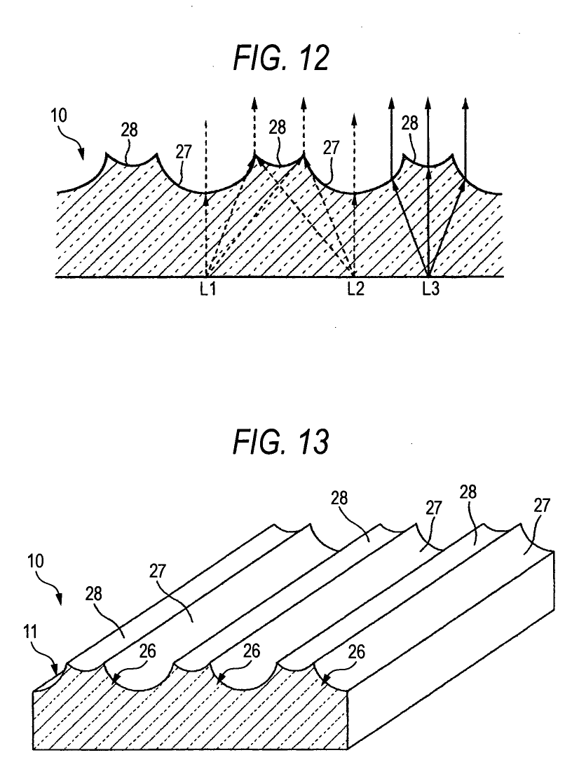

FIG. 10 is a sectional view showing a first embodiment of a prism lens film according to a second aspect of the present invention and a flat light emitting device using the prism lens film. FIG. 11 is a diagram for explaining the state of a curved surface in a sectional view of the prism lens film according to a second aspect of the present invention. FIG. 12 is a view showing a section of the prism lens film according to a second aspect of the present invention. FIG. 13 is a perspective view showing a prism lens film according to a second aspect of the present invention.

In the following explanation, members having the same constitutions and operations as those in the above-described first aspect are designated by the same reference numerals or equivalent reference numerals to simplify or omit the explanation.

As shown in FIGS. 10 and 13, on an upper surface of a prism lens film 11 as an output side surface, an irregular pattern composed of prism lenses is formed. The irregular pattern has substantially trapezoidal shapes in a sectional view and includes a plurality of lens parts 26 linearly arranged and extended along a planar direction of the output side surface. That is, the irregular pattern in the output side surface includes convex parts made of the lens parts 26 and concave parts defined between the lens parts 26.

In the prism lens film 11, first concave curved surfaces 27 are formed between the lens parts 26 and second concave curved surfaces 28 are formed on the upper surfaces of the lens pats 26. Both the first concave curved surfaces 27 and the second concave curved surfaces 28 are curves surfaces recessed toward the incident surface side of the prism lens film 11.

As shown in FIG. 10, in this embodiment, arranging pitches P11 and P12 of the lens parts 26 of the prism lens film 11 are equal and the dimension thereof is preferably located within a range of 3 μm to 300 μm. Further, the dimension P21, P22 and P23 of the second concave curved surfaces 28 on the upper surfaces of the lens parts 26 in the horizontal direction (rightward and leftward direction in FIG. 10) are equal. The dimension thereof preferably ranges from 1.5 μm to 150 μm.

An average size of the lens part 26 is preferably equal to or smaller than the size of a liquid crystal display element or a color filter. A cycle for arranging the lens parts 26 is preferably set to 5 μm to 500 μm.

The depth H1 of the lowermost pant of the first concave curved surface 27 is formed so as to be larger than the depth H2 of the lowermost part of the second concave curved surface 28 by setting the uppermost surface of the first concave curved surface 27 and the second concave curved surface 28 of the prism lens film 11 as a reference. The depth H1 of the lowermost part of the first concave curved surface 27 is preferably located within a range of from 1.5 μm to 150 μm. The depth H2 of the lowermost part of the second concave curved surface 18 is preferably located within a range of 0.4 μm to 40 μm.

FIG. 11 is a diagram for explaining the state of the prism lens film 11 in a sectional view. As shown in FIGS. 10 and 11, a back surface of the prism lens is set to an origin y=0. Further, x1 and x2 respectively show tops of the prism lens and the y coordinates thereof are respectively set to y1. Further, the y coordinate of the bottom part of the first concave curved surface 27 is set to y0 and the x coordinate of the bottom part of the second concave curved surface 28 is set to x3 and the y coordinate thereof is set to y3. Assuming that a coordinate in the direction of thickness of the prism is a y-axis an a coordinate in a planar direction of the prism is an x coordinate, curves Ca and Cc showing the first concave curved surface 27 and a curve Cb showing the second concave curved surface 28 are formed along a quadratic curve expressed by the following formula.
y=ax²+bx+c (in this case, a, b and c are constants) (Formula)

In FIG. 11, assuming that one pitch (one cycle) of the prism lens is P, P can be represented by P=P32+P22+P33 as shown in FIG. 11. At this time, P 32=P 22=P33 is established. Further, P32 is equal to P11/2 and P 33 is equal to P12/2.

A light H that is vertically incident from the back surface (x=0) of the prism lens and directed to the bottom part (y=0) of the first concave curved surface directly moves forward to the direction of I. Further, a light D that is obliquely incident from x=d of the back surface of the prism lens and moves to the first concave curved surface 27 (the curve Ca) is refracted on the first concave curved surface 27 and moves to the direction of E. Here, F designates a tangential line of the first concave curved surface 27, G designates a perpendicular intersecting at right angles to the tangential line F, θ1 designates an incident angle and θ2 designates an output angle. A light that is incident from the bottom part of the second concave curved surface can be substantially moved forward of the prism lens film.

When the light is incident on the prism lens film 11 of this embodiment from the incident side surface in a lower part, the light is refracted by the first concave curved surfaces located at both side surfaces of the lens parts 26 and the second concave curved surfaces located on the upper parts. Thus, the incident light located within a range from about −30° to +30° and a range from −45° to +45° of the light ranging from −90° to +90° (a direction perpendicular to the incident side surface is set to 0°) can be substantially vertically deflected.

As shown in FIG. 12, when light L1, L2 and L3 are incident on the prism lens film 11, the incident light having angles near to a perpendicular are directly output upward and an obliquely incident light having an angle wider than that of a usual light is refracted upward. Accordingly, the use efficiency of the light can be improved.

In the prism lens film 11 of this embodiment, the lens parts 26 having trapezoidal shapes in a sectional view are formed in the output side surface and the first concave curved surfaces 27 are formed between the lens parts 26. The light vertically incident on the incident side surface of the prism lens film 11 from the light source advance in the prism lens film 11 and a part of them is applied to the first concave curved surface 27 forming the side surface of the lens part 26. At this time, a pant in the first concave curved surface 27 irradiated with the light is formed to be recessed inward of the lens part 26. Thus, the vertically incident light is different in its reflected direction depending on its position in the horizontal direction. Consequently, since the vertically incident light is not uniformly reflected in the same direction as in the prism lens film 100 shown in FIG. 19, the incident light having an angle near to a perpendicular is directly output upward and the obliquely incident light having an angle wider than that of the usual light can be refracted upward. Accordingly, the use efficiency of the light can be improved.

Further, since a flat light emitting device 10 is provided with the prism lens film 11, the use efficiency of light emitted from a flat light source 12 can be improved. Accordingly, the flat light emitting device is applied to a display device so that the brightness of emitted light of a display screen can be increased.

In the prism lens film 11 of this embodiment, the lens parts 26 are irregularly arranged so that a moire resulting from the display of pixels of a liquid crystal can be prevented. As an irregular arrangement, for instance, a part or all of the lens parts 26 may be arranged at different intervals.

Further, two or more of the prism lens films 11 of this embodiment may be superposed so that the linear directions of the lens parts 26 in one of the prism lens films intersect at right angles to that in the adjacent prism lens film.

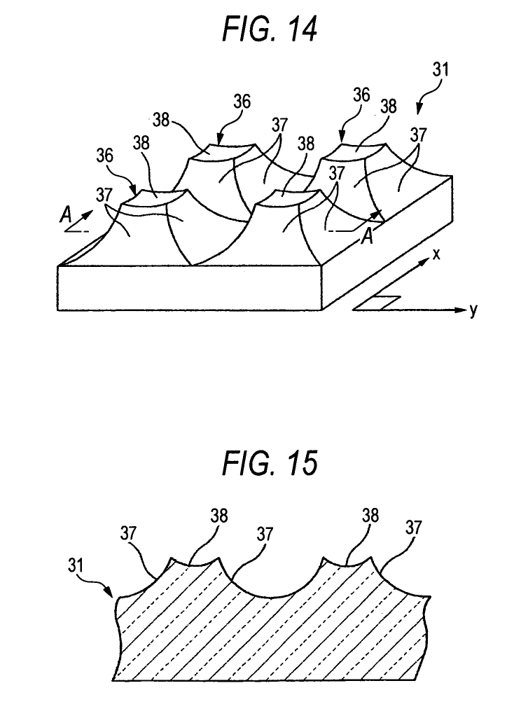

FIG. 14 shows a second embodiment of a prism lens film according to a second aspect pf the present invention. FIG. 15 shows a sectional view taken along a line A-A of FIG. 14. In the below-described embodiment, members having the same constituitons and operations as those of the already described members are designated by the same reference numerals or corresponding reference numerals in the drawings. Thus, an explanation is simplified or omitted.

As shown in FIG. 14, a prism lens film 31 has a constitution that lens parts 36 as substantially prism shaped members are two-dimensionally arranged on an output side surface. The lens part 36 has a substantially square shape in a top view and is formed so that the length of circumference is reduced toward an upper part. On four peripheral surfaces of the lens part 36, first concave curved surfaces 37 are formed between the adjacent lens parts 36. On an upper part of the lens part 36, a second concave curved surface 38 is formed.

As shown in FIG. 15, the lens part 36 is formed in a trapezoidal shape in a sectional view. Further, a section perpendicular to the section taken along the line A-A of FIG. 14 is the same as that shown in FIG. 15.

That is, in the prism lens film 31, the lens parts 36 are arranged at equal intervals on an x-y plane. The first concave curved surfaces 37 are formed between the lens parts 36 in the x direction and between the lens parts 36 in the y direction.

Under a state that the prism lens film 31 is viewed in section, the first concave curved surface 37 is formed along a quadratic curve represented by a mathematical formula described in the above-described embodiment.

The arranging pitch of the lens parts 36 and the dimension of the second concave curved surface 38 on the upper surface of the lens part 36 in the y direction can be provided so as to be located within the same ranges as those of the lens parts 26 in the prism lens film 11 of the above-described embodiment.

In the prism lens film 31 of this embodiment, since the lens part 36 is formed in a trapezoidal shape in a sectional view, a vertically incident light can be transmitted through the first concave curved surface 37 and output from the output side surface like the above-described embodiment. Thus, the use efficiency of the light can be enhanced.

The prism lens film 31 of this embodiment is stacked on a flat light source 12 as in the constitution shown in FIG. 10, so that a flat light emitting device capable of improving the use efficiency of light emitted from the light source can be obtained.

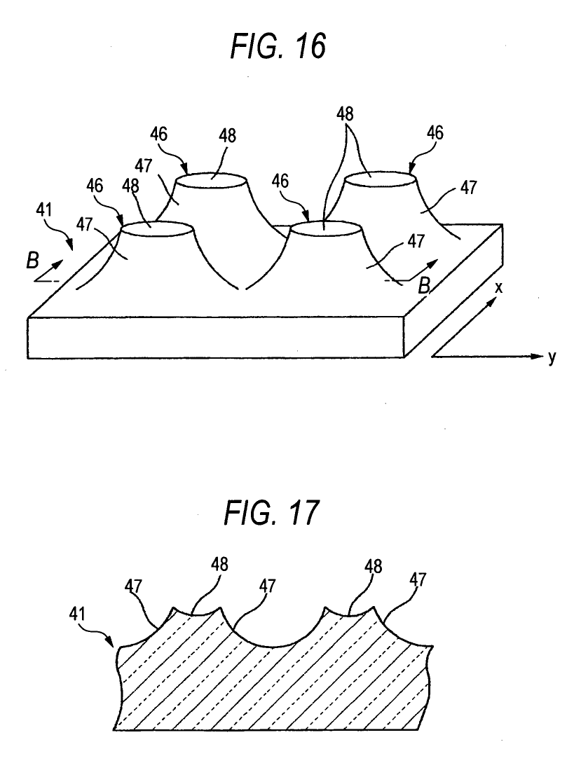

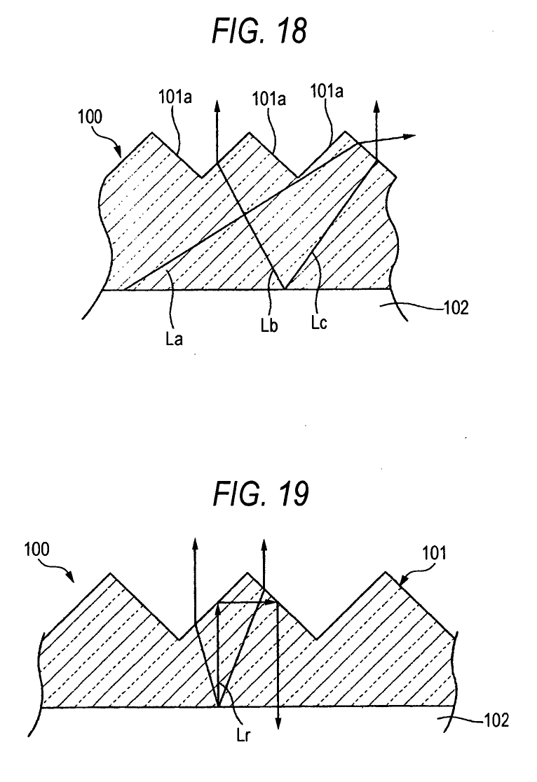

FIG. 16 shows a third embodiment of a prism lens film according to a second aspect of the present invention. FIG. 17 shows a sectional view taken along a line B-B of FIG. 16.

As shown in FIG. 16, a prism lens film 41 has a constitution that lens parts 46 as substantially cylindrical shaped members are two-dimensionally arranged on an output side surface. The lens part 46 has a circular shape in a top view and is formed so that the length of circumference is reduced toward an upper part. On a peripheral surface of the lens part 46, a first concave curved surface 47 is formed between the adjacent lens parts 46. On an upper part of the lens part 46, a second concave curved surface 48 is formed.

As shown in FIG. 17, the lens part 46 is formed in a trapezoidal shape in a sectional view. Further, a section perpendicular to the section taken along the line B-B of FIG. 16 is the same as that shown in FIG. 17.

That is, in the prism lens film 41, the lens parts 46 are arranged at equal intervals on an x-y plane in FIG. 17. The first concave curved surfaces 47 are formed between the lens parts 46 in the x direction and between the lens parts 46 in the y direction.

Under a state that the prism lens film 41 is viewed in section, the first concave curved surface 47 is formed along a quadratic curve represented by a mathematical formula described in the above-described embodiment.

The arranging pitch of the lens parts 46 and the dimension of the second concave curved surface 48 on the upper surface of the lens part 46 in the y direction can be provided so as to be located within the same ranges as those of the dimensions of the lens parts 26 and 36 in the prism lens films 11 and 31 of the first embodiment and the second embodiment.

In the prism lens film 41 of this embodiment, since the lens part 46 is formed in a trapezoidal shape in a sectional view, a vertically incident light can be deflected by the first concave curved surface 47 and output from the output side surface like the above-described embodiment. Thus, the use efficiency of the light can be enhanced.

The prism lens film 41 of this embodiment is laminated on a flat light source 12 as in the structure shown in FIG. 1, so that a flat light emitting device capable of improving the use efficiency of light emitted from the light source can be obtained.

It will be apparent to those skilled in the art that various modifications and variations can be made to the described embodiments of the present invention without departing from the spirit or scope of the invention. Thus, it is intended that the present invention cover all modifications and variations of this consistent with the scope of the appended claims and their equivalents.

This applications is based on Japanese Patent Application Nos. JP2005-34593 and JP2005-71042, filed on Feb. 10 and Mar. 14, 2005, respectively, the contents of which is incorporated herein by reference.

What is claimed is:

1. A prism lens film deflecting and outputting light introduced thereto, which comprises:
a plurality lens parts comprising an irregular pattern on a light-output side of the prism lens film, the irregular pattern deflecting the light; and
a reflecting parts between the lens parts, the reflecting parts reflecting the light.

2. The prism lens film according to claim 1, wherein the plurality of lens parts are linear parts arranged in parallel with a planar direction in a surface of the light-output side.

3. The prism lens film according to claim 1, wherein the plurality of lens parts is two-dimensionally arranged in parallel with a planar direction in a surface of the light-output side.

4. The prism lens film according to claim 1, wherein the lens parts are disposed at equal intervals.

5. The prism lens film according to claim 1, wherein at least a part of the lens parts are disposed at different intervals.

6. A prism lens film comprising a plurality of films superposed, the films including at least one prism film according to claim 1.

7. A prism lens film deflecting and outputting light introduced thereto, which comprises:
a plurality of lens parts comprising an irregular pattern on a light-output side of the prism lens film, the irregular pattern deflecting the light, the plurality of lens parts linearly extending along a planar direction in a surface of the light-output side; and
a first concave curved surface between the lens parts,
wherein each of the lens parts has a trapezoidal shape in a sectional view and has a second concave curved surface on an upper surface thereof.

8. The prism lens film according to claim 7, wherein at least a part of the lens parts are disposed at different intervals.

9. The prism lens film according to claim 7, wherein when a coordinate in a thickness direction in a sectional view of the prism lens film is set as a y-axis and a coordinate in a planner direction of the prism lens film is set as an x coordinate, the first concave curved surface is formed along a quadratic curve represented by formula:
y=ax²+bx+c
wherein a, b and c each independently is a constant value.

10. A prism lens film comprising two prism lens films each according to claim 7, the two prism lens films being superposed so that the lens parts in one of the two prism lens films intersect at right angles to the lens parts in the other of the two prism lens films.

11. A prism lens film deflecting and outputting light introduced thereto, which comprises:
a plurality of lens parts comprising an irregular pattern on a light-output side of the prism lens film, the irregular pattern deflecting the light, the plurality of lens prism films being two-dimensionally arranged along a planar direction in a surface of the light-output side; and
a first concave curved surface between the lens parts,
wherein each of the lens parts has a trapezoidal shape in a sectional view and has a second concave curves surface on an upper surface thereof.

12. The prism lens film according to claim 11, wherein at least a part of the lens parts are disposed at different intervals.

13. The prism lens film according to claim 11, wherein when a coordinate in a thickness direction in a sectional view of the prism lens film is set as a y-axis and a coordinate in a planner direction of the prism lens film is set as an x coordinate, the first concave curved surface is formed along a quadratic curve represented by formula:
y=ax²+bx+c
wherein a, b and c each independently is a constant value.

14. A prism lens film comprising a plurality of films superposed, the films including to at least one prism lens film according to claims 11.

15. A flat light emitting device comprising:
a prism lens film according to claim 1; and
a light source on a light-incident side of the prism lens film.

16. A flat light emitting device comprising:
a prism lens film according to claim 7; and
a light source on a light-incident side of the prism lens film.

17. A flat light emitting device comprising:
a prism lens film according to claim 11; and
a light source on a light-incident side of the prism lens film.
